(19) United States
(12) Patent Application Publication
(10) Pub. No.: US 2016/0109626 A1
(43) Pub. Date: Apr. 21, 2016

(54) COLOR FILTER AND LIQUID CRYSTAL DISPLAY DEVICE

(71) Applicant: AU Optronics Corporation, Hsin-chu (TW)

(72) Inventors: Kuei-Bai CHEN, Hsin-chu (TW); Chen-Hsien LIAO, Hsin-chu (TW); Chien-Kai CHEN, Hsin-chu (TW); Chia-Hao LI, Hsin-chu (TW)

(21) Appl. No.: 14/984,535

(22) Filed: Dec. 30, 2015

Related U.S. Application Data
(63) Continuation of application No. 13/523,487, filed on Jun. 14, 2012.

(30) Foreign Application Priority Data
Mar. 19, 2012 (TW) 101109370

(51) Int. Cl. G02B 5/22; G02F 1/1335

(52) U.S. Cl. CPC G02B 5/223; G02F 1/133514

(57) ABSTRACT

A color filter includes at least one blue color resist including a blue pigment and a violet dye, in which the ratio of the blue pigment to the blue color resist is in a range from 84.2% to 88.8% by weight, the ratio of the violet dye to the blue color resist is in a range from 11.2% to 15.8% by weight, so that a blue light with a y coordinate in a range from 0.045 to 0.051 in the CIE chromaticity diagram is generated when light passes through the blue color resist. Furthermore, a liquid crystal display device employing the color filter is also disclosed herein.

### RELATED APPLICATIONS

The present application is a Continuation Application of the application Ser. No. 13/523,487, filed Jun. 14, 2012, which claims priority to Taiwan Application Serial Number 101109370, filed Mar. 19, 2012, the disclosures of which are incorporated herein by reference in their entireties.

### BACKGROUND

1. Technical Field Disclosure

The embodiment of the present disclosure relates generally to an optical element, a system, or an instrument and, more particularly, to a color filter and a liquid crystal display device comprising the color filter.

2. Description of Related Art

Liquid crystal displays (LCDs) are being used as display devices more and more frequently because of their capability of displaying images with good quality while using little power. An LCD typically includes a liquid crystal panel and a backlight module, and light provided by the backlight module is used to display an image by control of the liquid crystal panel.

The color filter is employed in the liquid crystal panel such that light provided by the backlight module can be mixed in order to display colors of the image depending on requirements. The color filter usually includes red, green, and blue color resists. However, the transmittance of light is reduced when the light passes through the color resists of the color filter, which results in an insufficient brightness for the LCD.

According to the conventional way in which to increase brightness of an LCD, with respect to the color filter thereof, since the white point will generate a displacement quantity due to the change of the blue portion, when a high brightness of the blue portion is used, the efficiency of the backlight module is increased because of the white point shifting to the blue portion.

As a result, increasing transmittance of the blue portion by allocating the blue color resist to thereby enhance efficiency of the backlight module due to the white point shifting to the blue portion is an area of LCD technology that requires additional research.

### SUMMARY

A color filter and a liquid crystal display device comprising the color filter are provided, so as to increase transmittance of a blue portion by allocating the blue color resist to thereby enhance efficiency of the backlight module due to the white point shifting to the blue portion.

One aspect of the embodiment of the present disclosure is to provide a color filter. The color filter comprises at least one blue color resist including a blue pigment and a violet dye. The ratio of the blue pigment to the blue color resist is in a range from 84.2% to 88.8% by weight, and the ratio of the violet dye to the blue color resist is in a range from 11.2% to 15.8% by weight. When light passes through the blue color resist, a blue light with a y coordinate in a range from 0.045 to 0.051 in the CIE (International Commission on Illumination) chromaticity diagram is generated.

In another aspect of the embodiment of the present disclosure, a color filter is provided. The color filter comprises at least one blue color resist including a blue pigment and a violet dye. The ratio of the blue pigment to the blue color resist is in a range from 84.2% to 88.8% by weight, and the ratio of the violet dye to the blue color resist is in a range from 11.2% to 15.8% by weight. When light passes through the blue color resist, a blue light with a y coordinate in a range from 0.048 to 0.052 in the CIE chromaticity diagram is generated.

In yet another aspect of the embodiment of the present disclosure, a color filter is provided. The color filter comprises at least one blue color resist including a blue pigment and a violet dye. The ratio of the blue pigment to the blue color resist is in a range from 84.2% to 88.8% by weight, and the ratio of the violet dye to the blue color resist is in a range from 11.2% to 15.8% by weight. When light passes through the blue color resist, a blue light with a y coordinate that is less than about 0.055 in the CIE chromaticity diagram is generated.

In still another aspect of the embodiment of the present disclosure, a liquid crystal display device is provided. The liquid crystal display device comprises a yellow crystal powder type light emitting diode and a color filter. Furthermore, the color filter comprises at least one blue color resist including a blue pigment and a violet dye. The ratio of the blue pigment to the blue color resist is in a range from 84.2% to 88.8% by weight, and the ratio of the violet dye to the blue color resist is in a range from 11.2% to 15.8% by weight. The yellow crystal powder type light emitting diode is operable to radiate light. When the light passes through the blue color resist, a blue light with a y coordinate in a range from 0.045 to 0.051 in the CIE chromaticity diagram is generated.

In yet another aspect of the embodiment of the present disclosure, a liquid crystal display device is provided. The liquid crystal display device comprises a red crystal powder type light emitting diode and a color filter. Furthermore, the color filter comprises at least one blue color resist including a blue pigment and a violet dye. The ratio of the blue pigment to the blue color resist is in a range from 84.2% to 88.8% by weight, and the ratio of the violet dye to the blue color resist is in a range from 11.2% to 15.8% by weight. The red crystal powder type light emitting diode is operable to radiate light. When light passes through the blue color resist, a blue light with a y coordinate in a range from 0.048 to 0.052 in the CIE chromaticity diagram is generated.

In still another aspect of the embodiment of the present disclosure, a liquid crystal display device is provided. The liquid crystal display device comprises a cold cathode fluorescent lamp and a color filter. Furthermore, the color filter comprises at least one blue color resist including a blue pigment and a violet dye. The ratio of the blue pigment to the blue color resist is in a range from 84.2% to 88.8% by weight, and the ratio of the violet dye to the blue color resist is in a range from 11.2% to 15.8% by weight. The cold cathode fluorescent lamp is operable to radiate light. When light passes through the blue color resist, a blue light with a Y coordinate that is less than about 0.055 in the CIE chromaticity diagram is generated.

### BRIEF DESCRIPTION OF THE DRAWINGS

The disclosure can be more fully understood by reading the following detailed description of the embodiments, with reference made to the accompanying drawings as follows:

FIG. 1 schematically shows a contrast diagram of parameter values and backlight efficiency in the CIE chromaticity diagram according to embodiments of the present disclosure.

FIG. 2 schematically shows a contrast diagram of a change of a y coordinate point of blue light and backlight module efficiency according to embodiments of the present disclosure.

FIG. 3 schematically shows a mixture value diagram of the material of a blue color resist according to embodiments of the present disclosure.

FIG. 4 schematically shows a wave diagram of a yellow crystal powder type light emitting diode according to embodiments of the present disclosure.

FIG. 5 schematically shows a contrast diagram of parameter values and backlight module efficiency in the CIE chromaticity diagram according to embodiments of the present disclosure.

FIG. 6 schematically shows a contrast diagram of a change of a y coordinate point of blue light and backlight module efficiency according to embodiments of the present disclosure.

FIG. 7 schematically shows a mixture value diagram of the material of a blue color resist according to embodiments of the present disclosure.

FIG. 8 schematically shows a wave diagram of a red crystal powder type light emitting diode according to embodiments of the present disclosure.

FIG. 9 schematically shows a contrast diagram of parameter values and backlight module efficiency in the CIE chromaticity diagram according to embodiments of the present disclosure.

FIG. 10 schematically shows a contrast diagram of a change of a y coordinate point of blue light and backlight module efficiency according to embodiments of the present disclosure.

FIG. 11 schematically shows a mixture value diagram of the material of a blue color resist according to embodiments of the present disclosure.

FIG. 12 schematically shows a wave diagram of a cold cathode fluorescent lamp according to embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used herein, “around,” “about” or “approximately” shall generally mean within 20 percent, preferably within 10 percent, and more preferably within 5 percent of a given value or range. Numerical quantities given herein are approximate, meaning that the term “around,” “about” or “approximately” can be inferred if not expressly stated.

As used herein, the terms “comprising,” “including,” “having,” “containing,” “involving,” and the like are to be understood to be open-ended, i.e., to mean including but not limited to.

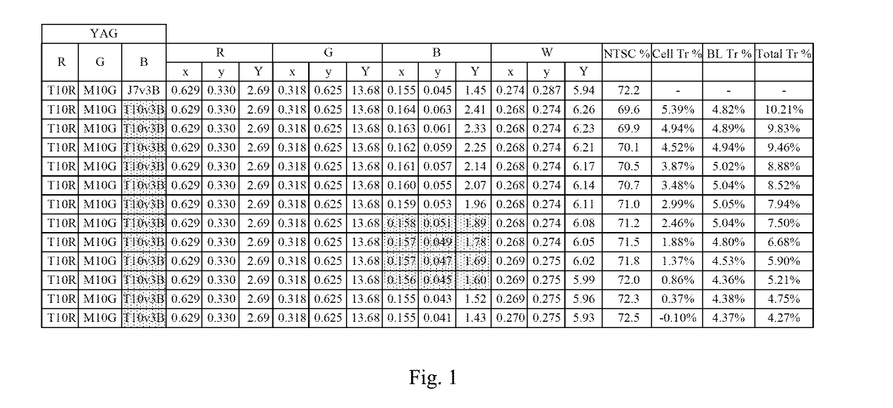

FIG. 1 schematically shows a contrast diagram of parameter values and backlight module efficiency in the CIE chromaticity diagram according to embodiments of the present disclosure. The contrast diagram is obtained through experimentation with respect to the color filter of the embodiment of the present disclosure. As shown in the figure, when a y coordinate point y of blue light in the CIE chromaticity diagram increases from about 0.045 to about 0.051, the luminance parameter Y of the blue light increases from about 1.60 to about 1.89 such that the white point in the CIE chromaticity diagram is shifted.

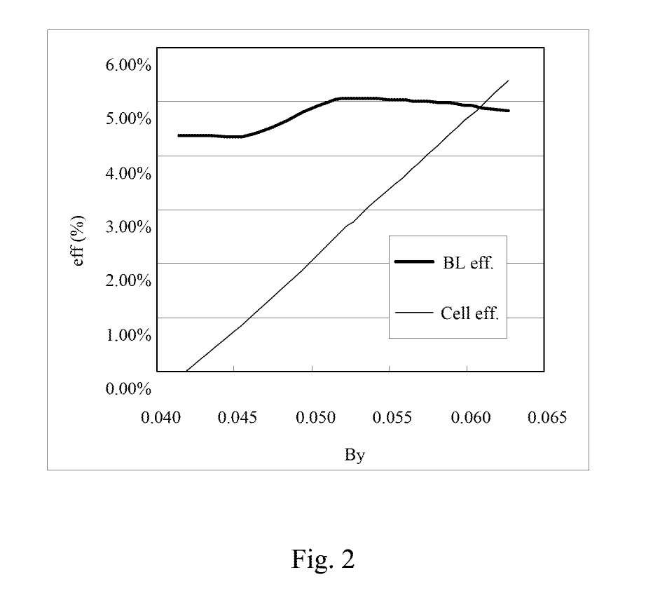

FIG. 2 schematically shows a contrast diagram of a change of a y coordinate point of blue light and backlight module efficiency according to embodiments of the present disclosure. The contrast diagram is obtained through experimentation with respect to the color filter of the embodiment of the present disclosure. As shown in the figure, the white point in the CIE chromaticity diagram is shifted due to a change of the y coordinate point of the blue light, so as to increase the efficiency of the backlight module. Moreover, when the y coordinate point of the blue light in the CIE chromaticity diagram increases from about 0.045 to about 0.051, the efficiency of the backlight module noticeably increases from 4.36% to 5.04%.

The embodiment of the present disclosure uses blue pigment and violet dye as the main material to manufacture a blue color resist, and this manner in which to manufacture a blue color resist is different from the conventional technique which uses blue pigment and violet pigment to manufacture the blue color resist. Compared with the conventional technique, when light passes through the blue color resist of the embodiment of the present disclosure, the amount of change of the y coordinate point of the blue light is larger. Furthermore, the amount of increase of the luminance parameter Y of the blue light is larger. Hence, the white point in the CIE chromaticity diagram is shifted noticeably, as is the efficiency of the backlight module.

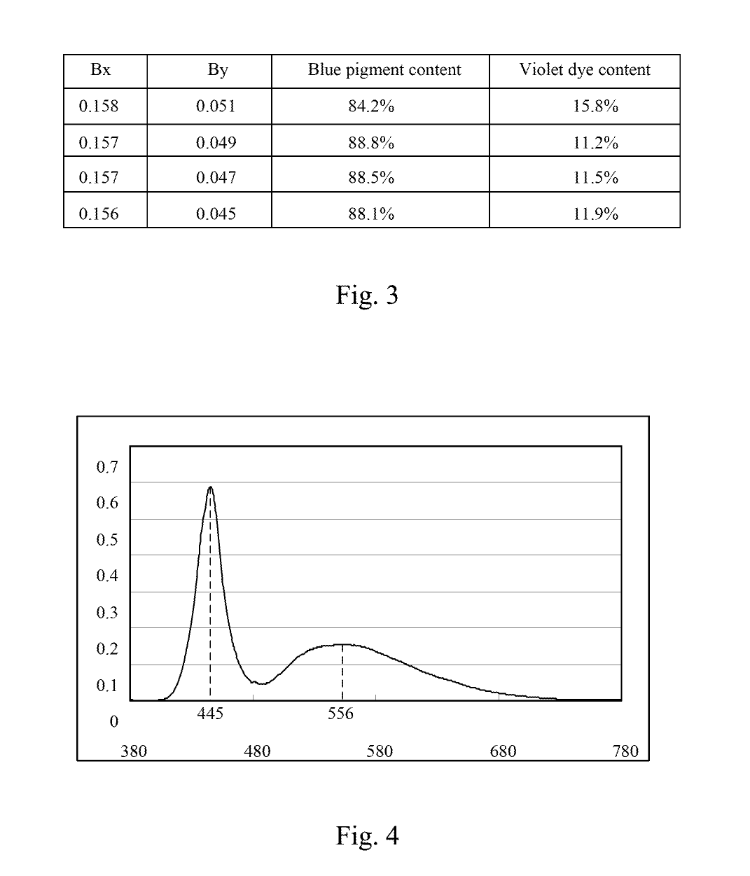

Specifically, the change of the y coordinate point of the blue light generated by allocating a mixture ratio of the material of the blue color resist, and the mixture ratio of the material of the blue color resist is shown in FIG. 3 which schematically shows a mixture value diagram of the material of a blue color resist according to embodiments of the present disclosure. As shown in the figure, the ratio of the blue pigment to the blue color resist is about 84.2%˜88.8% by weight, the violet dye is changed gradually corresponding to the blue pigment, and accordingly, the ratio of the violet dye to the blue color resist is about 15.8%˜11.2% by weight.

When implementing the violet dye and the blue pigment, the violet dye is mainly consisted of conventional materials such as Nitro Dye, Diphebnylmetane Dye, Azo Dye, Thiazol Dye, Azine Dye, Acridine Dye and Quinoline, and the blue pigment is mainly consisted of Phthalocyanine. However, the present disclosure is not intended to be limited to this regard, and those skilled in the art can selectively use proper materials to implement the violet dye and the blue pigment depending on actual requirements.

In another embodiment, one aspect of the embodiment of the present disclosure relates to a liquid crystal display device. The liquid crystal display device comprises a color filter and a yellow crystal powder type light emitting diode. The yellow crystal powder type light emitting diode is operable to radiate light. When light passes through the blue color resist, a blue light with a y coordinate in a range from 0.045 to 0.051 in the CIE chromaticity diagram is generated.

FIG. 4 schematically shows a wave diagram of a yellow crystal powder type light emitting diode according to embodiments of the present disclosure. As shown in the figure, the light of the yellow crystal powder type light emitting diode has a first peak at 445 nm of the spectrum, and the light of the yellow crystal powder type light emitting diode has a second peak at 556 nm of the spectrum.

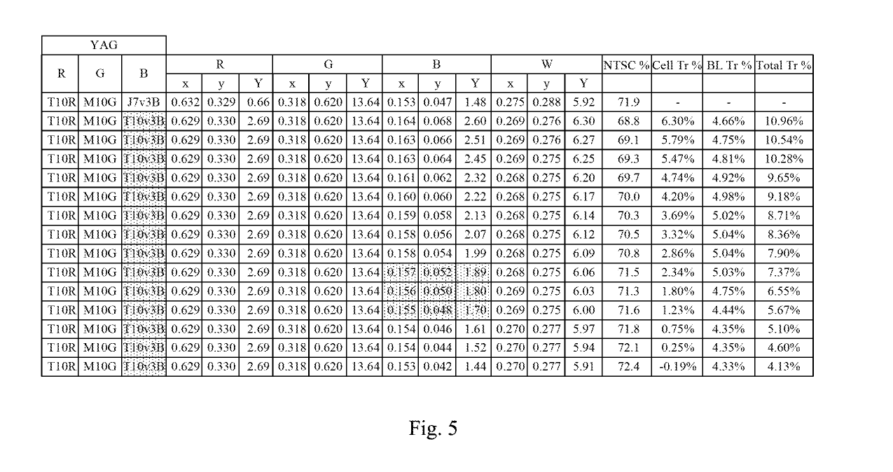

For improving the problem of transmittance of light being reduced when light passes through the color resist of the color filter to thereby make the brightness of an LCD insufficient, one aspect of the embodiment of the present disclosure is to provide a color filter which comprises at least one blue color resist, and a blue light with a y coordinate in a range from 0.048 to 0.052 in the CIE chromaticity diagram is generated when light passes through the blue color resist as shown in FIG. 5. Hence, the white point in the CIE chromaticity diagram is shifted to the blue portion, so as to increase the efficiency of the backlight module. A detailed implementation is described below.

FIG. 5 schematically shows a contrast diagram of parameter values and backlight module efficiency in the CIE chromaticity diagram according to embodiments of the present disclosure. As shown in the figure, when a y coordinate point of blue light in the CIE chromaticity diagram increases from about 0.048 to about 0.052, the luminance parameter Y of the blue light increases from about 1.70 to about 1.89 such that the white point in the CIE chromaticity diagram is shifted.

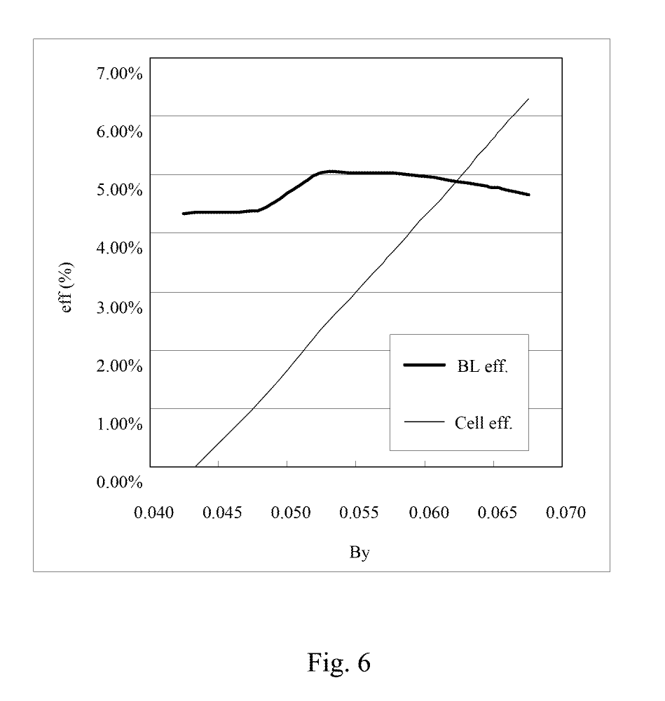

FIG. 6 schematically shows a contrast diagram of a change of a y coordinate point of blue light and backlight module efficiency according to embodiments of the present disclosure. The contrast diagram is obtained through experimentation with respect to the color filter of the embodiment of the present disclosure. As shown in the figure, the white point in the CIE chromaticity diagram is shifted due to a change of the y coordinate point of the blue light, so as to increase the efficiency of the backlight module. Moreover, when the y coordinate point of the blue light in the CIE chromaticity diagram increases from about 0.048 to about 0.052, the efficiency of the backlight module noticeably increases from 4.44% to 5.03%.

The embodiment of the present disclosure uses blue pigment and violet dye as the main material to manufacture a blue color resist, and this manner in which to manufacture a blue color resist is different from the conventional technique which uses blue pigment and violet pigment to manufacture the blue color resist. Compared with the conventional technique, when light passes through the blue color resist of the embodiment of the present disclosure, the amount of change of the y coordinate point of the blue light is larger. Furthermore, the amount of increase of the luminance parameter Y of the blue light is larger. Hence, the white point in the CIE chromaticity diagram is shifted noticeably, so as to increase the efficiency of the backlight module.

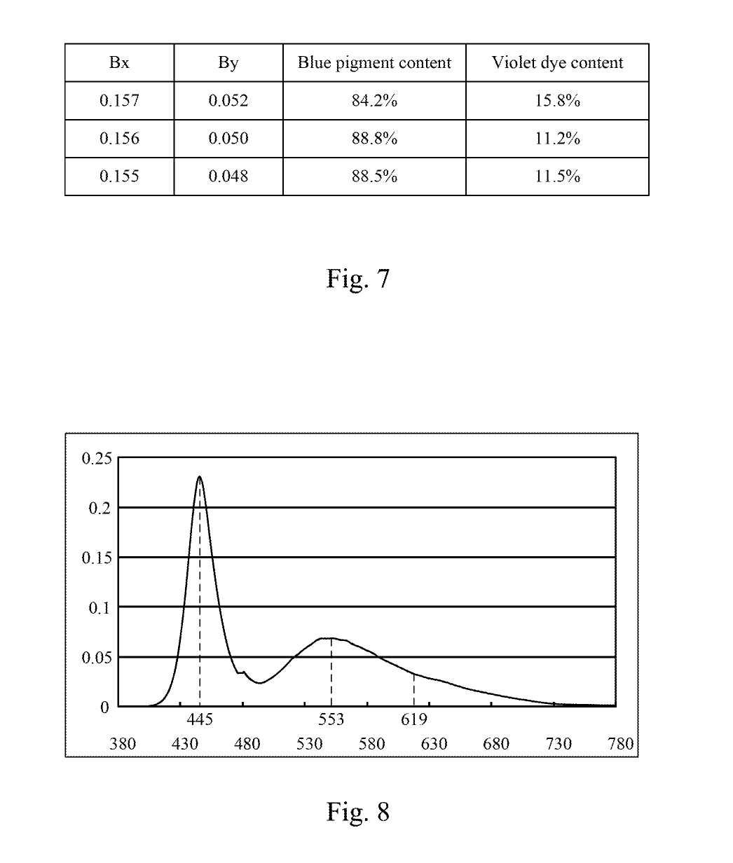

Specifically, the change of the y coordinate point of the blue light is generated by allocating a mixture ratio of the material of the blue color resist, and the mixture ratio of the material of the blue color resist is shown in FIG. 7 which schematically shows a mixture value diagram of the material of the blue color resist according to embodiments of the present disclosure. As shown in the figure, the ratio of the blue pigment to the blue color resist is about 84.2%˜88.8% by weight, the violet dye is changed gradually corresponding to the blue pigment, and accordingly, the ratio of the violet dye to the blue color resist is about 15.8%˜11.2% by weight. A description of the implementation of the violet dye and the blue pigment is provided above, and accordingly, a detailed description in this regard is omitted herein.

In another embodiment, one aspect of the embodiment of the present disclosure relates to a liquid crystal display device. The liquid crystal display device comprises a color filter and a red crystal powder type light emitting diode. The red crystal powder type light emitting diode is operable to radiate light. When light passes through the blue color resist, a blue light with a y coordinate in a range from 0.048 to 0.052 in the CIE chromaticity diagram is generated.

FIG. 8 schematically shows a wave diagram of a red crystal powder type light emitting diode according to embodiments of the present disclosure. As shown in the figure, the light of the red crystal powder type light emitting diode has a first peak at 445 nm of the spectrum, the light of the red crystal powder type light emitting diode has a second peak at 553 nm of the spectrum, and the light of the red crystal powder type light emitting diode has a third peak at 619 nm of the spectrum.

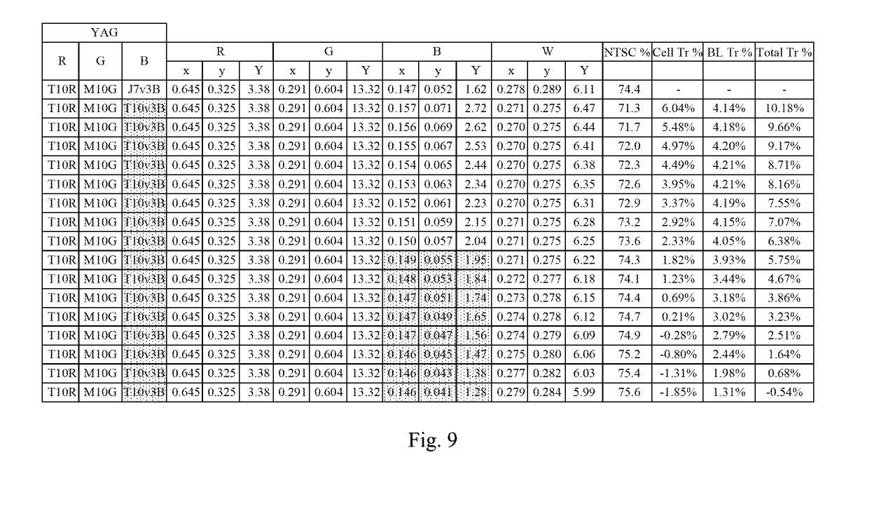

For improving the problem of transmittance of light being reduced when light passes through the color resist of the color filter to thereby make the brightness of an LCD insufficient, one aspect of the embodiment of the present disclosure is to provide a color filter which comprises at least one blue color resist, and a blue light with a y coordinate that is less than about 0.055 in the CIE chromaticity diagram is generated when light passes through the blue color resist as shown in FIG. 9. Hence, the white point in the CIE chromaticity diagram is shifted to the blue portion so as to increase the efficiency of the backlight module. A detailed implementation is described below.

FIG. 9 schematically shows a contrast diagram of parameter values and backlight module efficiency in the CIE chromaticity diagram according to embodiments of the present disclosure. The contrast diagram is obtained through experimentation with respect to the color filter of the embodiment of the present disclosure. As shown in the figure, when a y coordinate point of blue light in the CIE chromaticity diagram increases from about 0.041 to about 0.055, the luminance parameter Y of the blue light increases from about 1.28 to about 1.95 such that the white point in the CIE chromaticity diagram is shifted. It is noted that the data in FIG. 9 is merely used to interpret the embodiment of the present disclosure. As shown in FIG. 9, a noticeable result will be realized when the y coordinate point of the blue light is less than about 0.055.

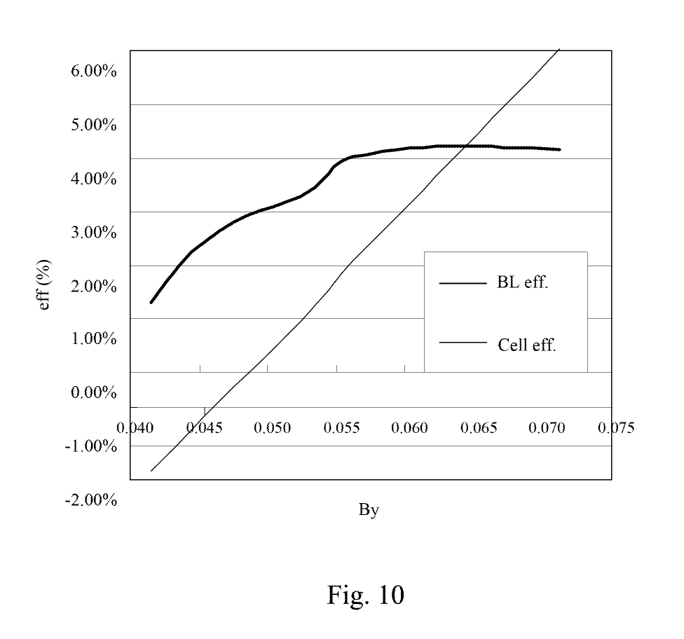

FIG. 10 schematically shows a contrast diagram of a change of a y coordinate point of blue light and backlight module efficiency according to embodiments of the present disclosure. As shown in the figure, the white point in the CIE chromaticity diagram is shifted due to a change of the y coordinate point of the blue light, so as to increase the efficiency of the backlight module. Moreover, when the y coordinate point of the blue light in the CIE chromaticity diagram increases from about 0.041 to about 0.055, the efficiency of the backlight module noticeably increases from 1.31% to 3.93%.

The embodiment of the present disclosure uses blue pigment and violet dye as the main material to manufacture a blue color resist, and this manner in which to manufacture a blue color resist is different from the conventional technique which uses blue pigment and violet pigment to manufacture the blue color resist. Compared with the conventional technique, when light passes through the blue color resist of the embodiment of the present disclosure, the amount of change of the y coordinate point of the blue light is larger. Furthermore, the amount of increase of the luminance parameter Y of the blue light is larger. Hence, the white point in the CIE chromaticity diagram is shifted noticeably, so as to increase the efficiency of the backlight module.

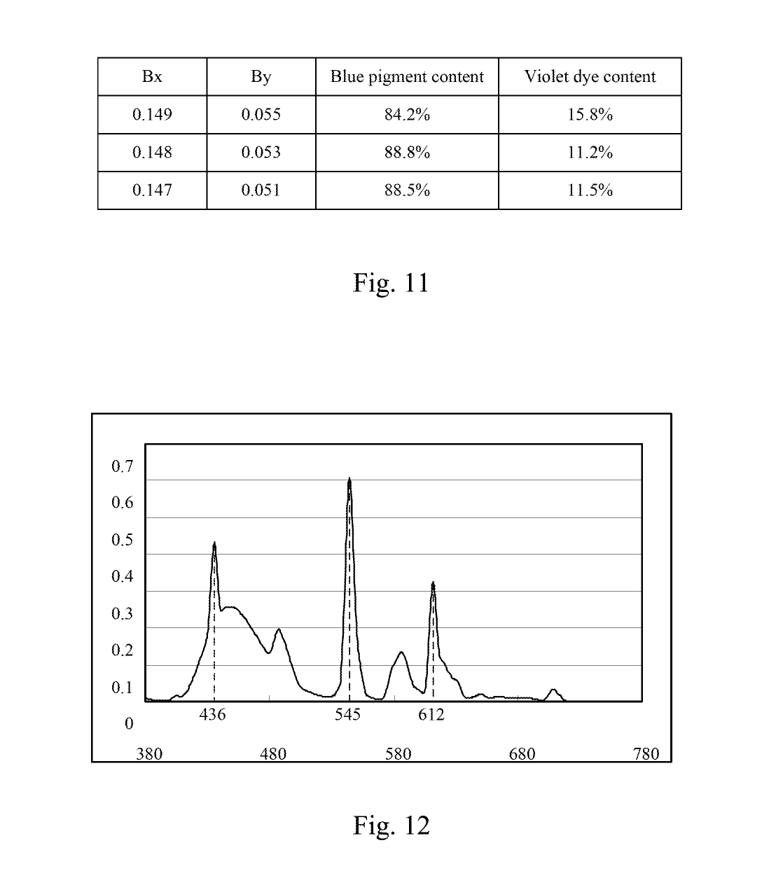

Specifically, the change of the y coordinate point of the blue light is generated by allocating a mixture ratio of the material of the blue color resist, and the mixture ratio of the material of the blue color resist is shown in FIG. 11 which schematically shows a mixture value diagram of the material of a blue color resist according to embodiments of the present disclosure. As shown in the figure, the ratio of the blue pigment to the blue color resist is about 84.2%˜88.8% by weight, the violet dye is changed gradually corresponding to the blue pigment, and accordingly, the ratio of the violet dye to the blue color resist is about 15.8%˜11.2% by weight. The implementation of the violet dye and the blue pigment is described above, and accordingly, a detailed description in this regard is omitted herein.

In another embodiment, one aspect of the embodiment of the present disclosure relates to a liquid crystal display device. The liquid crystal display device comprises the color filter and the cold cathode fluorescent lamp. The cold cathode fluorescent lamp is operable to radiate light. When light passes through the blue color resist, a blue light with a y coordinate that is less than about 0.055 in the CIE chromaticity diagram is generated.

FIG. 12 schematically shows a wave diagram of a cold cathode fluorescent lamp according to embodiments of the present disclosure. As shown in the figure, the light of the cold cathode fluorescent lamp has a first peak at 436 nm of the spectrum, the light of the cold cathode fluorescent lamp has a second peak at 545 nm of the spectrum, and the light of the cold cathode fluorescent lamp has a third peak at 612 nm of the spectrum.

In view of the foregoing embodiments of the present disclosure, many advantages of the present disclosure are now apparent. The embodiment of the present disclosure provides a color filter and a liquid crystal display device, so as to increase transmittance of a blue portion by allocating a blue color resist, thereby enhancing efficiency of a backlight module due to the white point shifting to the blue portion. In addition, the blue color resist of the embodiment of the present disclosure comprises a blue pigment and a violet dye, and the mixture ratio of the blue pigment to the violet dye can be allocated depending on actual requirements. Compared with the prior art, the embodiment of the present disclosure can make the white point shift by a significant amount in CIE chromaticity diagram, so as to noticeably increase the efficiency of the backlight module.

It will be understood that the above description of embodiments is given by way of example only and that various modifications may be made by those with ordinary skill in the art. The above specification, examples and data provide a complete description of the structure and use of exemplary embodiments of the disclosure. Although various embodiments of the disclosure have been described above with a certain degree of particularity, or with reference to one or more individual embodiments, those with ordinary skill in the art could make numerous alterations to the disclosed embodiments without departing from the spirit or scope of this disclosure, and the scope thereof is determined by the claims that follow.

What is claimed is:

1. A color filter, comprising:
at least one blue color resist comprising a blue pigment and a violet dye, wherein the ratio of the blue pigment to the blue color resist is in a range from 84.2% to 88.8% by weight, the ratio of the violet dye to the blue color resist is in a range from 11.2% to 15.8% by weight, and when light passes through the blue color resist, a blue light with a y coordinate in a range from 0.045 to 0.051 in the CIE chromaticity diagram is generated.

2. The color filter according to claim 1, wherein the violet dye is selected from the group consisted of nitro dyes, diphebnylmetane dyes, thiazol dyes, acridine dyes, and quinolines, and the blue pigment is phthalocyanine.

3. The color filter according to claim 1, wherein the ratio of the violet dye is changed gradually corresponding to the ratio of the blue pigment.

4. A color filter, comprising:
at least one blue color resist comprising a blue pigment and a violet dye, wherein the ratio of the blue pigment to the blue color resist is in a range from 84.2% to 88.8% by weight, the ratio of the violet dye to the blue color resist is in a range from 11.2% to 15.8% by weight, and when light passes through the blue color resist, a blue light with a y coordinate in a range from 0.048 to 0.052 in the CIE chromaticity diagram is generated.

5. The color filter according to claim 4, wherein the violet dye is selected from the group consisted of nitro dyes, diphebnylmetane dyes, thiazol dyes, acridine dyes, and quinolines, and the blue pigment is phthalocyanine.

6. The color filter according to claim 4, wherein the ratio of the violet dye is changed gradually corresponding to the ratio of the blue pigment.

7. A color filter, comprising:
at least one blue color resist comprising a blue pigment and a violet dye, wherein the ratio of the blue pigment to the blue color resist is in a range from 84.2% to 88.8% by weight, the ratio of the violet dye to the blue color resist is in a range from 11.2% to 15.8% by weight, and when light passes through the blue color resist, a blue light with a y coordinate that is less than about 0.055 in the CIE chromaticity diagram is generated.

8. The color filter according to claim 7, wherein the violet dye is selected from the group consisted of nitro dyes, diphebnylmetane dyes, thiazol dyes, acridine dyes, and quinolines, and the blue pigment is phthalocyanine.

9. The color filter according to claim 7, wherein the ratio of the violet dye is changed gradually corresponding to the ratio of the blue pigment.
